(19) United States
(12) Patent Application Publication
(10) Pub. No.: US 2012/0284246 A1
(43) Pub. Date: Nov. 8, 2012

(54) ADVANCED PERSONAL MEDIA PLAYER

(75) Inventor: Daniel White, Gainesville, GA (US)

(73) Assignee: NCR CORPORATION, Duluth, GA (US)

(21) Appl. No.: 13/099,434

(22) Filed: May 3, 2011

(51) Int. Cl. G06F 17/30

(52) U.S. Cl. 707/706; 707/769; 707/E17.108

(57) ABSTRACT

A system for locating and presenting video content. A search is done for events of interest to a user. When events of interest are identified, a search for video content covering the events is done. When video content is found, it is recorded. Then the video content is transmitted to a mobile device of the user. In one form of the invention, the search is of the conceptual type, and not a key-word search formulated by the user.

The invention relates to a system which (1) searches out video content which suits the preferences of a user, (2) records or streams the live video content, and (3) delivers the recorded or live content to a mobile device of the user.

### BACKGROUND OF THE INVENTION

As the technology of video recording advances in capability and decreases in cost, the amount of video footage available to the public increases immensely. Because of the vast array of video content available, people may have difficulty in locating desired content, and particularly in doing so in a timely and convenient manner.

The invention allows a user to obtain relevant video content in a simple manner, with little or no constraint on the user's time.

### OBJECTS OF THE INVENTION

An object of the invention is to provide an improved video recording system.

A further object of the invention is to provide a video recording system which (1) locates video content of interest to a user, (2) records the content, and (3) transmits the recorded content to a mobile device in possession of the user.

### SUMMARY OF THE INVENTION

In one form of the invention, a search is done to locate video content of interest to a user. When the content is located, it is recorded, or otherwise made available for transfer, and then transmitted to a mobile device of the user.

### BRIEF DESCRIPTION OF THE DRAWINGS

FIG. 1 illustrates one form of the invention.

FIG. 2 illustrates a schedule of television programming, in which a user designates material to be recorded.

FIG. 3 illustrates conceptually a sequence of related television programs to be recorded.

FIG. 4 is a flow chart of processes undertaken by one form of the invention.

### DETAILED DESCRIPTION OF THE INVENTION

### Overview

The invention accepts general indications from a user as to subjects which are of interest to the user, such as (1) sports games of a given team, (2) political events involving specified politicians or candidates, (3) newsworthy events on stated topics, and so on. The invention also can accept highly specific indications, such as designation of a football game of a given team on a given day, or of newsworthy events relating to a specific event, such as the launch of a particular spacecraft at a given time.

After receiving indications of the user's preferences, the invention searches repositories of video content to locate video footage which conforms to the preferences.

The invention can also locate video content which is not specified by the user's preferences, but is considered noteworthy by the general public or the user's social network and thus would be of interest to the user.

When footage is found, the invention either records it directly, streams it live to the user, or inquires of the user whether it should be recorded. After recording, the invention transfers the video content to a mobile device of the user.

### Detailed Discussion

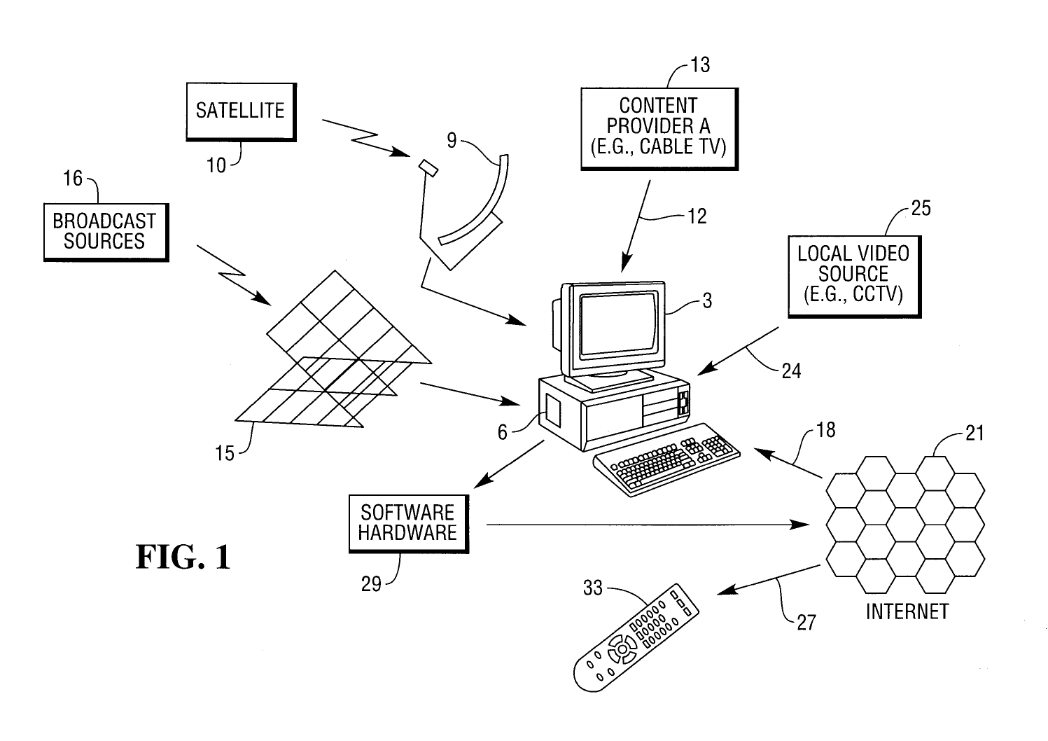

FIG. 1 illustrates equipment used by one form of the invention. A computer 3, or other management device, contains software 6 and extra hardware 29, if required, which performs the functions described herein, such as recording video content. The software 6 may formulate search queries itself, or may cooperate with remote software (not shown) in that task.

The computer 3 receives video content from numerous sources. Antenna 9 represents a receiver of video content from an artificial earth satellite 10. Line 12 represents receipt of video content from agencies 13 such as a cable television provider. Antenna 15 represents receipt of over-the-air broadcast television from sources 16. Line 18 represents a connection to the Internet 21.

Line 24 represents a connection to one or more local video cameras 25, such as Closed Circuit TeleVision, CCTV, cameras. These cameras may view a person's home or business, as security cameras. The footage generated by these cameras will be searchable by time-of-recording, so that the searching described herein can be done on that basis, to locate footage recorded on a specific date and time.

Arrow 27 indicates a connection, wireless or wired, between the Internet and a mobile device 33, which is under control of a user (not shown). The video which is recorded under control of the computer 3 is transmitted from the recording device to the mobile device 33, via the channel indicated by arrow 27.

The terms video and video content are not taken to strictly exclude pure audio content. Sometimes the invention will record pure audio content, and deliver it to the mobile device. This would also not exclude relevant text headlines for picture and graphic files.

The Inventor points out that it is not strictly necessary that the physical recording of the video content occur at the site of computer 3. For example, the video content to be located often comprises individual video frames, and each frame can be viewed as a packet of data. These packets can be stored at any convenient storage location. An analogy can be drawn to electronic mail. People receive electronic mail, with attached data packets, at their e-mail providers. The latter store the mail and packets, until retrieval. The video packets in question can similarly be stored remotely. The actual computer may not reside at the user's residence, but could be located as a server or other computing device somewhere on the internet that multiple users could access and store their preferences.

### Recording Pre-Scheduled Content

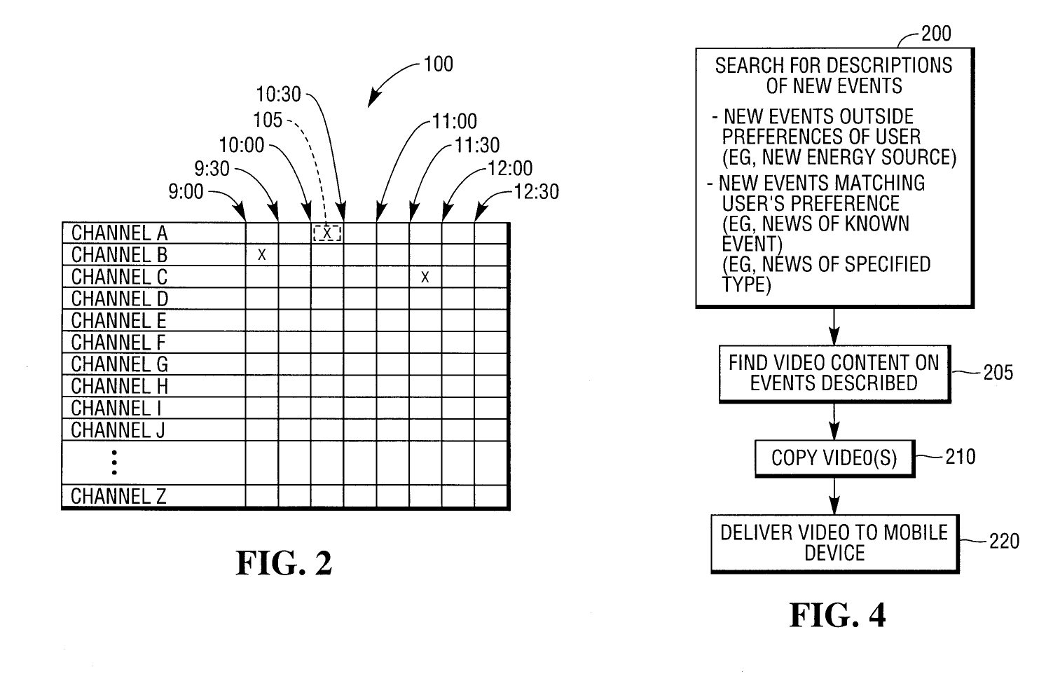

The video content, which is recorded or streamed live to the mobile device 33, can be classified as two types. One type is pre-scheduled video content. This type includes video content provided by television stations and cable television providers, for example. This type of content is described in schedules which are published in advance, such as the schedule 100 shown in FIG. 2. Such schedules are available on the Internet and other locations, and can be searched by computer 3 in FIG. 1.

Each block in the schedule 100 in FIG. 2, such as block 105, indicates a block of time assigned to a specific channel. The schedule 100 also describes the video content corresponding to each block of time, as by giving the name of a television program. (Descriptions are not shown.)

The user of the invention designates which blocks of time, and the corresponding channels, for which video content is to be recorded. The X's in the Figure indicate these designations. Automated equipment, associated with the computer 3 of FIG. 1, records the designated video content at the correct times. Then the recorded content is made available to the mobile device 33 in FIG. 1, as by transmitting the content over the Internet. Devices which perform this transmission are known in the art.

The approach just described records individually selected elements of video content. That is, each individual element is designated separately by the user, as indicated by the X's in FIG. 2.

In another approach, the user can schedule recording of a related series of pre-scheduled content. For example, the user may wish to schedule recording or live streaming of all football games in a given season played by a specific university, and wishes to perform the scheduling at one single time. Most people prefer to watch sporting events live in order to immediately know the outcome, so having a live streaming option is important. As another example, the user may wish to record a sequence of debates between a pair of political candidates.

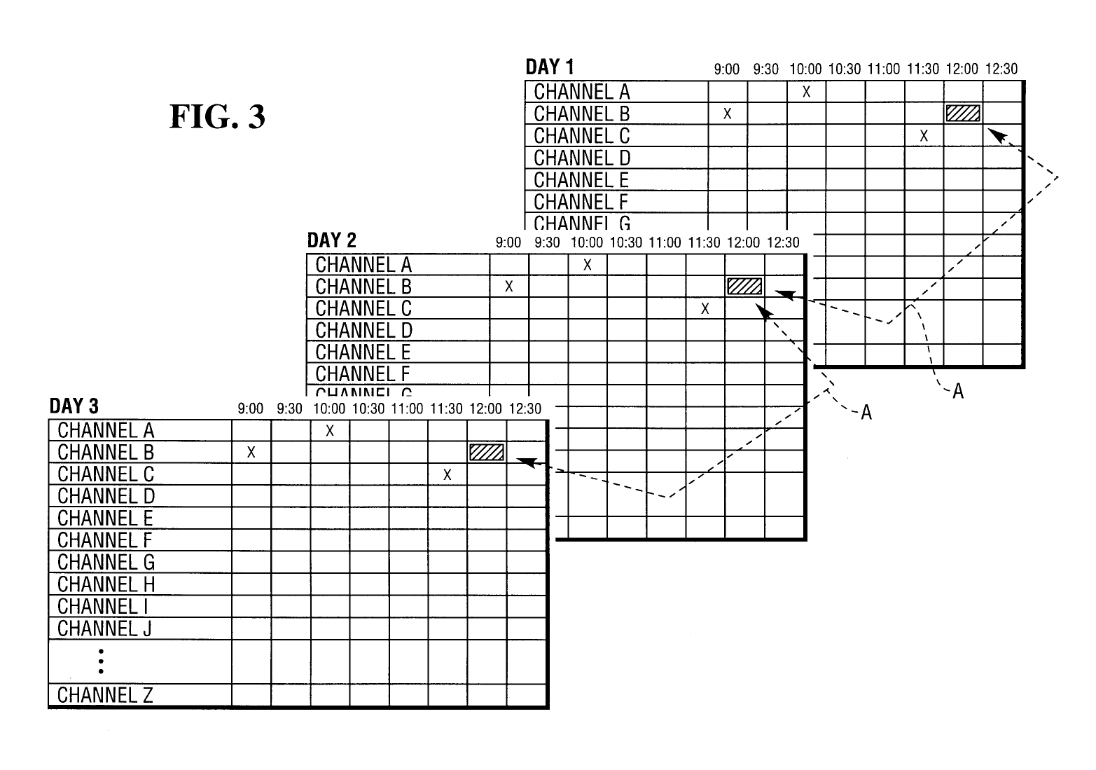

FIG. 3 indicates diagrammatically the scheduling of a sequence of events in this manner. FIG. 3 shows a pictorial diagram, for ease of explanation. However, in actual practice, a data table will probably be used. The table will contain individual sequences, such as (1) all football games for College A, (2) all basketball games for College B, (3) all debates of a pair of candidates, and so on.

For each individual sequence, a list of the dates, times, and channels for all events in the sequence is stored in the table. The stored data is used to schedule recording of the events in a sequence. The user selects a sequence of interest, indicated by arrows A in FIG. 3, and the sequence is recorded.

The system may also be tied to the user's normal entertainment channel whether on his mobile device or television at home. When a series of shows are viewed, the system may prompt the user to add this show to his sequence of interest for future recording or viewing. For example, if the user has watched two of the NCAA basketball tournament games, the system can recognize this and ask if he wants to see all of them, or give an option as to which ones he is interested in. Similarly, if two shows in a particular series is viewed, the system can ask if all the shows in the series should be recorded.

Pre-scheduled video content has been discussed. That may also include a specific type of scheduled event, but whose precise time of occurrence is not known in advance. For example, the Space Shuttle, owned by the National Aeronautics and Space Administration (NASA) of the United States, is generally scheduled for a launch on a given date. However, the exact time of lift-off is not known because of weather- and mechanical delays. This type of pre-scheduled content is perhaps best treated as non-scheduled content, for practical reasons, and will be described below.

A similar type of content would include continuing documentation of an event which has already occurred, such as the continuing news coverage of a natural disaster. The date and time of broadcasting of such coverage is probably not known in advance. This type is also discussed below.

### Non-Scheduled Content

The second type of video content which the invention records includes non-scheduled, or spontaneous, content, such as reports of a natural disaster. The second type of content is not limited to content classified as news, but includes video content generally.

The invention can take a two-step approach. The first step is to identify the events (ie, the types of content) which are desired by the user. The second step would be to actually retrieve and record video covering those events.

As to the first step (identifying subject matter), the Inventor points out that two types of identification are contemplated. In one type of identification, a search is done to locate content which conforms to fields of interest specified by the user. For example, a given user may specify that he is interested in contact sports, sailing, stamp collecting, and flower gardening. A search would look for video content made available between dates specified by the user on those topics.

In the second type of identification, a search is done to discover new events, but without reference to preferences of the user, under the assumption that certain new events would be of interest to the user, if the user knew of them. For example, a discovery of a new source of energy may have occurred. A person may wish to know of this, but may not even be aware of the possibility of the discovery, and thus could not express a preference.

Several approaches can be taken in this first step, which identifies video content of interest to the user. Four approaches will be outlined, and then each described.

In one approach to the first step, subject matter which has recently become prominent in the public mind can be identified. One example of such subject matter would be a natural disaster.

In a second approach to the first step, subject matter is identified which is of interest to a specific subset of the general public. One example would be the renewal of an employment contract of a prominent athlete, or the results of a certain yacht race, both of which would probably be of interest only to sports enthusiasts.

In a third approach to the first step, subject matter is identified which is of interest to a specific third party (as opposed to the general public, or a subset thereof, as in the first two approaches). The third party is considered to be a type of authority or arbiter of public taste, so that the third party is assumed to know the disposition of the public mind. One example of such a third party would be a news reporting agency, or wire service. The content of interest would be, for example, the news items on the first page of its web edition of its newspaper.

In a fourth approach to the first step, some subject matter identified by the first three approaches is selected, but some is rejected. This is a filtering operation. One example would be that the first approach, above, would identify the death of a famous person as of interest to the public in general. However, under the fourth approach, obituaries are specifically rejected by the particular user of the invention. Thus, the content in question would not be pushed to the mobile device, because of the fourth approach.

These four approaches will be discussed further.

In the first approach (of the first step of identifying subjects of interest), subject matter of interest to the public in general is identified. This subject matter is analogous to that called breaking news or headlines. Such subject matter can be identified by polling observers and commentators of the news media, and thereby identifying new topics.

For example, the subjects most discussed by a random sample of blogs (which is jargon for web log, a commentary posted on the Internet), or web sites, or web pages maintained by members of social networks, and the like can be scanned by a search engine or drone. The search looks for items recently posted within a predetermined time period. The search then looks, within those items, for selected words corresponding to the preferences of the user. In this example, the user submits a list of subject preferences.

On the other hand, the search can attempt to identify new events, outside the preferences of the user. For instance, the search results may show that, in 50 postings at a given web forum, the following was found:

| WORD FOUND | NUMBER OF OCCURRENCES |
|---|---|
| Tsunami | 24 |
| Flood | 18 |
| Drown | 15 |

### And so on.

This particular example indicates that a certain type of flood has caused drownings. The invention selects events which are most under discussion, as indicated by the frequencies of the words found.

Therefore, in general, the first approach can locate descriptive terms which have recently come into prominence in generalized communications on the Internet, or which relate to preferences submitted by a user. Block 200 in FIG. 4 represents this operation.

In this connection, the Inventor points out that linguists, and others, have assembled statistics which indicate the frequencies of words used by newspapers. It has been found that the overall vocabulary used in newspapers, at least in English, is somewhat restricted, and contains a relatively small number of words. Thus, in one form of the invention, a list of such words (excluding small words such as a, the, etc.) is presented to the user. The user can select words expected to describe events of interest. The search engine then looks for those words in the posts which are examined.

Alternately, the search engine can be alerted to find words which are outside the short list just described.

Therefore, in the first approach, selected web sites, or other forums where the public undertakes discussions, are examined. Words in recent postings are identified, and the most frequent of those words are identified. Or words in recent postings which correspond to preferences stated by the user are identified. This identification process is taken as indicating popular topics of discussion, and thus indicating new events, since the topics are recent.

In the second approach of the first step, a search similar to that of the first approach is taken, but at particular locations, wherein content is of a particular type. As a specific example, web sites exist which are devoted to particular subjects, and are often called forums. The subjects include physics, psychology, religion, sports, and others. The search of the type described above is done of recent postings, but within a specific forum, or equivalent.

In the third approach of the first step, a search is done of a third party's collection of news items, such as a newspaper or wire service. The type of search can be that outlined above. For example, a search of the front page of a web edition of a given day's newspaper can be done for the descriptive terms deduced above (tsunami, flood, and drowning).

As another example, an RSS (Really Simple Syndication) feed can be subscribed to a news organization, such as CNN (Cable News Network). A search can be done of the incoming RSS feed to identify subjects of interest.

Therefore, as discussed so far, in the first, second, and third approaches, a search is undertaken with the goal of finding discussions of (1) recent events which would be of interest to the user, or (2) recent events which are presumed to be of interest to the user, independent of his stated preferences.

In the fourth approach, the search results are restricted, or filtered, to eliminate unwanted results. For example, the invention can maintain a list of topics, analogous to a list of subject categories used by a library. The user can select topics which are to be suppressed or accepted.

### Location Based Content

The last type of content that may only be relevant depending on the user's location is local events that may directly impact the user. Severe weather, local natural disasters, traffic accidents, jail breaks, and other events in the direct vicinity of the user are of specific interest to the user. He may want to know about various dangers to avoid them or events that he may want to attend in person. By utilizing the contextual search capabilities previously explained, combined with the GPS location system built into the user's mobile device, the system can add another layer of relevant and timely information directly to the user.

The GPS can also be a trigger for the system to alert the user of a scheduled event. For example, if the user is at home when a scheduled football game is occurring, the system could simply alert the user that the event is happening at that particular time, and he could watch on his television instead of the mobile device.

### Recapitulation

A search is done electronically, or by computer, to locate discussions of events which (1) have occurred within a time frame set by the user, and (2) lie within subject categories established by the user. In addition, discussions are located which are presumed to interest the user. Blocks 205 and 210 in FIG. 4 represent these steps.

The categories can be defined through active involvement by the user. For example, the user can provide a list of key words. The invention searches for discussions which contain the key words.

The categories can also be defined without the active participation of the user, as by using generally accepted categories used by institutions which collect and classify information. The Dewey Decimal System represents one such system of categories. The user selects categories of interest from a list of categories.

Then, without further involvement of the user, video content is recorded, as by recording onto computer 3 in FIG. 1. Recorded content it transmitted to the mobile device 33, via the Internet.

### Additional Embodiments

The categories can also be defined by archetypical example. For instance, the user may encounter a news story on a specific topic, such as the eruption of a specific volcano. Conceptual searching facilities exist which allow the user to locate similar stories, but without a requirement that the user reduce the content of the article to a combination of key words for a search. The conceptual searching facility, in essence, does that, based on the article, which is submitted to the search facility.

A basic principle of conceptual searching is to find concepts, as opposed to mere symbols, in the database searched. For example, if one does a key word search using the key word box using an Internet search engine, one will obtain hits which relate to (1) the sport of fisticuffs, or boxing, and (2) cardboard packaging, or boxes.

In contrast, a conceptual search engine will ascertain the user's intended meaning, and design a search which pursues the concept which the user had in mind, and suppress hits on other concepts.

In one approach of a conceptual search, the search engine is equipped by its designer with listings of alternate meanings for search terms. This type of search engine asks the user which meaning is intended (fisticuffs or packaging in the example above).

The search engine is equipped with combinations of search terms which are intended to locate hits on the desired meaning, and suppress hits on the non-intended meaning. For example, if the user selects the sport of fisticuffs, the search engine may add some or all of the key words ring, ropes, round, bell, gloves, trunks, title, belt, champion, and so on, which are terms expected in articles written by sports writers about the sport of boxing. Suitable negative key words may be used also, such as not packaging, not cardboard, and so on, to suppress hits on packing boxes.

The individual user could, of course, fashion such combinations of key words himself. However, the conceptual search engine itself performs this task.

Therefore, one aspect of a conceptual search engine, or conceptual search query, is that it intends to locate material in a database based on a concept, rather than a single key word.

In another form of the invention, the conceptual search uses an initial search in order to locate a subject, and then uses background information which it knows about the subject to generate a more refined search. An example will illustrate.

In year 2011, a large earthquake struck Japan. Newspaper articles about the earthquake may contain the terms earthquake, Japan, tsunami, and nuclear. Thus, a user may use some, or all, of those key words to locate discussions in the Internet on this earthquake.

The conceptual search engine is trained to recognize the specific event which the user is seeking, which is the earthquake occurring off the northeast coast of Japan in March, 2011. The conceptual search engine may ask for confirmation of this conclusion from the user.

Once the conceptual search engine has ascertained the specific event sought by the user (the particular earthquake in this example), the conceptual search engine then consults background tables of terms associated with this event. The tables are designed by the designer of the search engine.

In this particular example, the tables may contain the additional terms of Tokyo Electric Power Company, TEPCO, radiation leakage, and so on. The search engine then compiles another search, using some or all of the additional search terms, in addition to the original search terms. The second search will be broader than the first. For example, the second search here will certainly get hits on Tokyo Electric Power Company, whereas the initial search may not.

Therefore, in one form of the invention, a user submits an archetypical text, such as a newspaper story, describing an event. The user wishes to identify similar events. The conceptual search engine receiving the story formulates a search query, and uses the query to find similar events.

The search engine may identify the specific event of the text, and then locate other search terms which others have prepared for that event, in preparing the search query. The results will be identification of similar events to that of the archetypical text. The invention uses the results to locate video content on the similar events.

### Additional Considerations

1. The following patents, many of which relate to conceptual database searching, are hereby incorporated by reference.

U.S. Pat. No. 6,668,256, issued Dec. 23, 2003, inventor is Lynch.

U.S. Pat. No. 7,206,303, issued Apr. 17, 2007, inventor is Karas.

U.S. Pat. No. 7,272,594, issued Sep. 18, 2007, inventor is Lynch.

U.S. Pat. No. 7,292,979, issued Nov. 6, 2007, inventor is Karas.

U.S. Pat. No. 7,512,900, issued Mar. 31, 2009, inventor is Lynch.

2. The Inventor wishes to distinguish two types of searching. On the one hand, one may consider a word processing document. One type of search would be of the brute force type, in which one searches the entire document, beginning to end, for the word plasma. In this search, a computer examines every word in the document.

On the other hand, one may use an index, as that term is used in database technology. A database contains documents. The custodian of the database processes each document, and makes an alphabetical list of important words, indicating the location of each word in the document.

When a user searches this database, the search engine examines the indices of the documents for the word plasma. The search engine then points to the documents containing that word, if any. Significantly, the search engine does not perform a brute force search of all the documents.

In one form of the invention, searches of indexed databases are specifically contemplated, to the exclusion of brute force searches of databases. Internet searching is typically a search of indices.

3. The term mobile device refers to a portable device operated by an individual, and used in the individual's personal affairs. The device can display video. Modern cell phones, Personal Digital Assistants (PDAs), notebook computers and the like provide examples of mobile devices. One characteristic of a mobile device is that it can be carried by a person onto a commercial airliner, along with the person's normal luggage, without significant cost or trouble.

It specifically does not refer, for example, to the collection of video equipment contained within a vehicle used by a television news crew to gather news reports.

4. The invention should be distinguished from the mere downloading of a movie from a movie rental service. It may be true that a person searches the inventory of the rental service, selects a movie, and then downloads it, perhaps to a mobile device.

However, one form of the invention records video content at a site, and then transfers the content to the mobile device. That is not seen in the movie rental.

Further, one form of the invention uses a search to identify events, and then a second search to locate video content on the events. The video content uncovered may be automatically recorded. That is not seen in the movie rental.

5. One definition of the term “time sensitive” is that the market value of time sensitive content becomes significantly diminished after the first publication of the content. For example, the World Series games in American baseball are time-sensitive. After a game completes, and the final score becomes known, demand for viewing a recording of the entire game becomes significantly reduced. There may be a demand for recorded highlights of the game, but not the same demand for a recording of the game itself.

6. Another definition is based on subsequent treatment of the content. If an original event is broadcast on one medium, such as pay-per-view television, then recordings of the content are transmitted on a different, less remunerative, medium, such as video cassettes. The fact that the recording is broadcast, or distributed, on a less remunerative medium indicates that the value of the content has diminished.

For example, a given professional prize fight may involve the boxer Mohammed Ali, formerly known as Cassius Clay, and may be broadcast on a live television system. But it is broadcast on that system only once, namely, at the time of the fight. Thereafter, video cassettes may become available of the same fight, but, again, no re-broadcast of the fight on the same television system has occurred.

Of course, if the fight were to occur in a foreign country, and be unavailable in another country at the time, then the principle just discussed would apply when the fight was first broadcast in the other country. The first broadcast in the other country is not analogous to the distribution of video cassettes. Conversely, if the video cassettes were the only available medium in the other country, then they would be equivalent to an original broadcast.

7. Yet another definition of “time sensitive” is that a primary interest of the audience lies in the outcome of the event. Once the outcome of the event becomes known to the public, demand for witnessing the entire event drops significantly.

One quantitative definition for “time sensitive” is that (1) promoters or sponsors of the original event earn revenue from the event, such as through ticket sales and receipts from advertisers and (2) the total possible revenue from a single subsequent presentation of a recording of the event is less than one-half of the original revenue.

Time sensitive events can be location specific. For example, events can occur in a given city (a specific location), but news of the events can be time sensitive, in the sense that, once the news is known, the event is no longer considered so important. As a specific example, a barge may collide with a given bridge, and rendered the bridge unusable. Persons who use the bridge would wish to know of that immediately after the event. But once they know of the event, they change their driving habits, and the event loses significance. Therefore, news of the event is time sensitive to a specific location.

8. Significance of an event can be determined as described previously. For example, if a certain threshold of commentators at a web site or news reporting organization discuss a specific event, it may be determined to be significant. As another example, if a certain event is described on page 1 or 2 of a web version of a local newspaper, it may be deemed significant.

Numerous substitutions and modifications can be undertaken without departing from the true spirit and scope of the invention as defined in the following claims. What is desired to be secured by Letters Patent is the invention as defined in the following claims.

1. A method, comprising:
a) delivering a description to a conceptual search engine, and using the conceptual search engine to identify events which match the description;
b) performing a search to locate video content of the events identified;
c) recording the video content; and
d) delivering the video content to a mobile device under control of a user who delivered the description.

2. Method according to claim 1, in which (1) the conceptual search engine formulates a search query based on the description, and (2) the user does not formulate a query.

3. Method according to claim 1, wherein the description comprises archetypical text.

4. A method, comprising:
a) maintaining a system which (i) has access to multiple video programs, (ii) selects programs for presentation to a user, based on a list of preferences, and (iii) presents other programs to the user;
b) monitoring said other programs and, if a group of them meet predetermined criteria of similarity, then giving the user an option of adding said criteria to said list of preferences; and
c) after adding said criteria to said list, selecting programs for presentation to the user, based on the criteria now in the list.

5. A method, comprising:
a) using a device to perform a search for time sensitive video content which meets criteria specified by a user;
b) using the device to (i) notify the user of video content found in the search and (ii) give the user an option to receive the video content on a mobile device controlled by the user; and
c) if the user exercises the option, causing the video content to be transmitted to the mobile device.

6. A method according to claim 5, in which the video content is transmitted to the mobile device over the Internet.

7. Method according to claim 5, in which the criteria describe sports events of a specified team.

8. Method according to claim 5, in which the criteria describe events which occur in a specified location, thereby causing the search to ignore video content relating to events outside said location.
